(19) United States
(12) Patent Application Publication
(10) Pub. No.: US 2017/0167546 A1
(43) Pub. Date: Jun. 15, 2017

(54) CLUTCH DEVICE

(71) Applicant: HONDA MOTOR CO., LTD., Tokyo (JP)

(72) Inventors: Yuhi Satoi, Saitama (JP); Kazuha Miura, Saitama (JP)

(21) Appl. No.: 15/341,446

(22) Filed: Nov. 2, 2016

(30) Foreign Application Priority Data
Dec. 14, 2015 (JP) 2015-243420

(51) Int. Cl. F16D 13/52; B60K 6/365; F16D 13/38; B60K 6/547; F16H 3/091; F16H 3/72; F16H 37/04; B60K 6/387; F16H 3/00

(52) U.S. Cl. CPC F16D 13/52; B60K 6/387; B60K 6/365; F16D 13/385; F16H 3/006; F16H 3/091; F16H 3/724; F16H 37/042; B60K 6/547; Y10S 903/914; Y10S 903/91; B60Y 2200/92; B60Y 2400/424; B60Y 2400/73; B60Y 2400/428

(57) ABSTRACT

A clutch device 1 is provided with a first clutch C1 and a second clutch C2, which disengageably transmit a rotational motion. The first clutch C1 includes a first outer drum 111, first outer plates 111a, a first inner hub 113, and first inner discs 113a. The second clutch C2 includes a second outer drum 121, second outer plates 121a, a second inner hub 123, and second inner discs 123a. The first outer drum 111 and the second outer drum 121 are connected, and the second inner hub 123 is journaled by the first inner hub 113 through the intermediary of a ball bearing 131.

### BACKGROUND OF THE INVENTION

Field of the Invention

The present invention relates to a clutch device used with a transmission or the like.

Description of the Related Art

Hitherto, a clutch device used with a transmission or the like has been known (refer to, for example. Japanese Patent Application Laid-Open No. 2015-175463). The clutch device described in Japanese Patent Application Laid-Open No. 2015-175463 is used with a so-called dual clutch transmission, in which a first clutch and a second clutch are adjacently provided.

In a clutch device, a thrust bearing could be disposed between the inner hub of a first clutch and the inner hub of a second clutch to enable easy relative rotation of these two inner hubs.

However, there is a problem that the inner hub of the second clutch tends to incline.

### SUMMARY OF THE INVENTION

In view of the above, an object of the present invention is to provide a clutch device capable of preventing a second output member, such as an inner hub of a second clutch, from inclining.

To this end, the present invention provides a clutch device comprising: a first clutch and a second clutch that disengageably transmit a rotational motion, wherein

the first clutch includes:

a first outer drum;

a first outer plate which is slidable in an axial direction with respect to the first outer drum and which is connected to an inner wall so as to rotate integrally with the first outer drum;

a first inner hub concentrically disposed on an inner side in a radial direction of the first outer drum; and

a first inner disc which is slidable in the axial direction with respect to the first inner hub, which is connected to an outer wall so as to rotate integrally with the first inner hub, and which is frictionally engageable with the first outer plate,

the second clutch includes:

a second outer drum;

a second outer plate which is slidable in the axial direction with respect to the second outer drum and which is connected to an inner wall so as to rotate integrally with the second outer drum;

a second inner hub concentrically disposed on an inner side in a radial direction of the second outer drum; and

a second inner disc which is slidable in the axial direction with respect to the second inner hub, which is connected to an outer wall so as to rotate integrally with the second inner hub, and which is frictionally engageable with the second outer plate,

one of the first outer plate and the first inner hub is defined as a first input member and the other is defined as a first output member,

one of the second outer plate and the second inner hub is defined as a second input member and the other is defined as a second output member,

the first input member and the second input member are connected, and

the second output member is journaled by the first output member through a ball bearing.

According to the present invention, the second output member is securely held by the first output member through the ball bearing, thus making it possible to prevent the second output member from inclining.

### BRIEF DESCRIPTION OF THE DRAWINGS

FIG. 1 is a schematic diagram illustrating a power transmission apparatus equipped with an embodiment of a clutch device in accordance with the present invention:

FIG. 2 is a sectional view schematically illustrating the clutch device according to the present embodiment; and

FIG. 3 is a sectional view schematically illustrating a clutch device of a comparative example.

### DESCRIPTION OF THE PREFERRED EMBODIMENTS

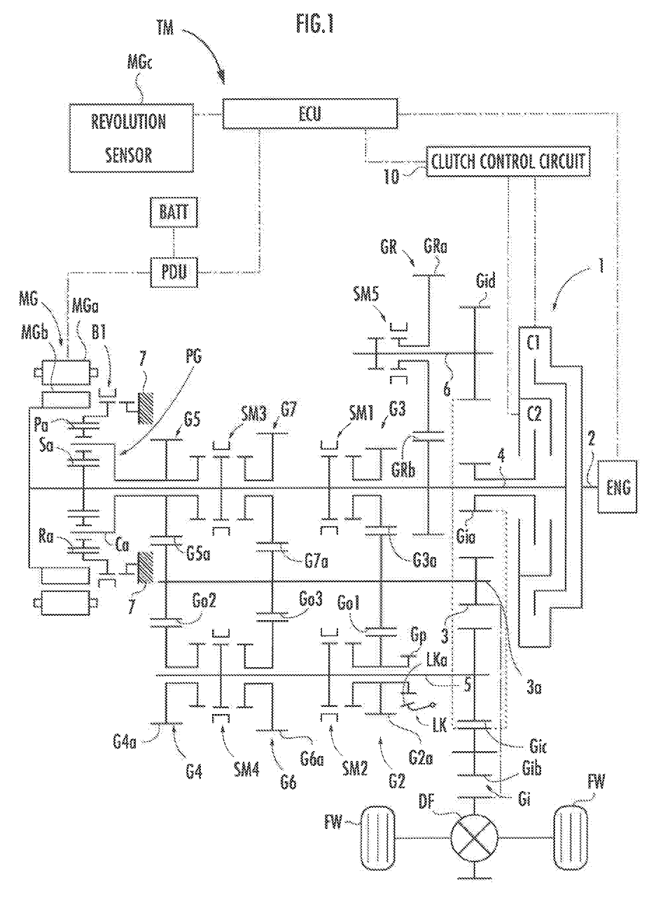

FIG. 1 illustrates a power transmission apparatus TM equipped with a clutch device 1 according to a first embodiment. The power transmission apparatus TM includes an input shaft 2 to which the driving force (output torque) of an internal combustion engine ENG serving as a drive source is transmitted, an output shaft 3a having an output gear 3, which outputs power to left and right front wheels FW serving as drive wheels through a differential gear DF, and a plurality of gear trains G2 to G7 having different transmission gear ratios.

The power transmission apparatus TM further includes a first drive shaft 4, which rotatably journals drive gears G3a, G5a and G7a of odd-numbered gear trains G3, G5 and G7, which establish the odd-numbered transmission stages in the order of transmission ratio, a second drive shaft 5, which rotatably journals drive gears G2a, G4a and G6a of even-numbered gear trains G2, G4 and G6, which establish the even-numbered transmission stages in the order of transmission ratio, and a reverse shaft 6, which rotatably journals a reverse drive gear GRa of a reverse stage gear train GR, which is used to establish a reverse stage and which is composed of a reverse drive gear GRa and a reverse driven gear GRb. The first drive shaft 4 is disposed on the same shaft line as the input shaft 2, while the second drive shaft 5 is disposed in parallel to the first drive shaft 4.

The power transmission apparatus TM further includes an idle gear train Gi composed of an idle drive gear Gia rotatably journaled by the first drive shaft 4, a first idle driven gear Gib meshed with the idle drive gear Gia, a second idle driven gear Gic which is meshed with the first idle driven gear Gib and fixed to the second drive shaft 5, and a third idle driven gear Gid meshed with the first idle driven gear Gib and fixed to the reverse shaft 6.

The power transmission apparatus TM has a first clutch C1 and a second clutch C2, which are composed of hydraulically actuated wet friction clutches. The first clutch C1 is configured to be switchable between an engaged mode, in which the driving force of the internal combustion engine ENG transmitted to the input shaft 2 is transmitted to the first drive shaft 4 and a disengaged mode, in which the transmission is interrupted. The second clutch C2 is configured to be switchable between the engaged mode, in which the driving force of the internal combustion engine ENG transmitted to the input shaft 2 is transmitted to the second drive shaft 5 and the disengaged mode, in which the transmission is switched off.

Both of the clutches, C1 and C2, can be switched between the modes by the hydraulic pressure supplied from a clutch control circuit 10. Further, the engaging pressure of both of the clutches, C1 and C2, in the engaged mode can be adjusted (to the so-called half-clutch mode) by adjusting the hydraulic pressure by an actuator (not illustrated) provided in the clutch control circuit 10.

Further, in the power transmission apparatus TM, a planetary gear mechanism PG is disposed, being positioned coaxially with the input shaft 2. The planetary gear mechanism PG is comprised of a single pinion type, which is composed of a sun gear Sa, a ring gear Ra, and a carrier Ca which rotatably and revolvably journals a pinion Pa meshed with the sun gear Sa and the ring gear Ra.

If the three elements, namely, the sun gear Sa, the carrier Ca, and the ring gear Ra, of the planetary gear mechanism PG are defined as a first element, a second element, and a third element from a sun gear Sa side (one side) in the order of arrangement at intervals corresponding to gear ratios in a collinear chart (a chart that makes it possible to illustrate the relative revolution speeds of the individual elements by straight lines), then the first element will be the sun gear Sa, the second element will be the carrier Ca, and the third element will be the ring gear Ra.

Further, if the gear ratio of the planetary gear mechanism PG (the number of teeth of the ring gear Ra/the number of teeth of the sun gear Sa) is denoted by g, then the ratio of the interval between the sun gear Sa, which is the first element, and the carrier Ca, which is the second element, with respect to the interval between the carrier Ca, which is the second element, and the ring gear Ra, which is the third element, will be g:1 in the collinear chart.

The sun gear Sa, which is the first element, is fixed to the first drive shaft 4. The carrier Ca, which is the second element, is connected to the fifth-speed drive gear G5a of the fifth-speed gear train G5. The ring gear Ra, which is the third element, is disengageably fixed to a transmission case 7 by a lock mechanism B1 (the brake).

The lock mechanism B1 (the brake) is comprised of a synchronous meshing mechanism and is configured to be switchable between a locked mode, in which the ring gear Ra (the third element) is locked to the transmission case 7, and a disengaged mode, in which the ring gear Ra is unlocked.

The planetary gear mechanism PG may be comprised of a double-pinion type composed of a sun gear, a ring gear, and a carrier that rotatably and revolvably journals a pair of pinions, which intermesh with each other and one of which meshes with the sun gear and the other of which meshes with the ring gear. In this case, for example, the sun gear (the first element) may be locked to the first drive shaft 4, the ring gear (the second element) may be connected to the fifth-speed drive gear G5a of the fifth-speed gear train G5, and the carrier (the third element) may be releasably locked to the transmission case 7 by the lock mechanism B1 (the brake).

A hollow electric motor MG (motor generator), which is a rotating electric device, is disposed on the outer side in the radial direction of the planetary gear mechanism PG. In other words, the planetary gear mechanism PG is disposed on the inner side relative to the hollow electric motor MG. The electric motor MG has a stator MGa and a rotor MGb. The rotor MGb has a rotor hub that extends toward the input shaft 2. The rotor hub is splined to the first drive shaft 4.

Further, the electric motor MG is controlled through a power drive unit PDU on the basis of an instruction signal of a power control unit ECU (Electronic Control Unit). The power control unit ECU appropriately switches the operation mode of the power drive unit PDU between a drive mode, in which the power of a secondary battery BATT is consumed to drive the electric motor MG and a regenerative mode, in which the rotation force of the rotor MGb is restrained to generate power and the generated power is charged into the secondary battery BAIT through the power drive unit PDU.

Further, the electric motor MG is provided with a revolution sensor MGc, which detects the number of revolutions of the electric motor MG (the number of revolutions of the rotor MGb). The revolution sensor MGc is configured to be capable of transmitting the detected number of revolutions of the electric motor MG to the power control unit ECU.

The power control unit ECU is an electronic unit comprised of a CPU, memories and the like, and adapted to run, by the CPU, a control program held in a storage unit, such as a memory. The power control unit ECU receives signals of a shift mechanism, which is switched to one of a forward range, a neutral range, a reverse range, and a parking range by the shifting operation performed by a driver. The power control unit ECU also receives the operation information of a brake mechanism, which applies a brake to wheels by a braking operation performed by the driver stepping on a brake pedal.

Fixed to the first drive shaft 4 is the reverse driven gear GRb meshed with the reverse drive gear GRa of the reverse stage gear train GR rotatably journaled by the reverse shaft 6. Fixed to the output shaft 3a, which journals the output gear 3, is a first driven gear Go1 meshed with a second-speed drive gear G2a and a third-speed drive gear G3a. Also fixed to the output shaft 3a is a second driven gear Go2 meshed with a fourth-speed drive gear G4a and the fifth-speed drive gear G5a. Further fixed to the output shaft 3a is a third driven gear Go3 meshed with a sixth-speed drive gear G6a and a seventh-speed drive gear G7a.

As described above, the driven gear of the second-speed gear train G2 and the third-speed gear train G3, the driven gear of the fourth-speed gear train G4 and the fifth-speed gear train G5, and the driven gear of the sixth-speed gear train G6 and the seventh-speed gear train G7 are each comprised of a single gear, namely, Go1, Go2, and Go3, respectively, thereby making it possible to shorten the axial length (the dimension in the axial direction) of the power transmission apparatus TM, thus permitting easier installation on an FF (front-wheel-drive) type vehicle.

The first drive shaft 4 is provided with a first meshing mechanism SM1 and a third meshing mechanism SM3, which are each comprised of synchronous meshing mechanisms. The second drive shaft 5 is provided with a second meshing mechanism SM2 and a fourth meshing mechanism SM4, which are each comprised of synchronous meshing mechanisms. The first meshing mechanism SM1 is configured to be switchable to either a third-speed-side connection mode, in which the third-speed drive gear G3a and the first drive shaft 4 are connected, or a neutral mode, in which the third-speed drive gear G3a and the first drive shaft 4 are disconnected.

The third meshing mechanism SM3 is configured to be switchable among a fifth-speed-side connection mode, in which the fifth-speed drive gear G5a and the first drive shaft 4 are connected, a seventh-speed-side connection mode, in which the seventh-speed drive gear G7a and the first drive shaft 4 are connected, and a neutral mode, in which the third-speed drive gear G3a and the seventh-speed drive gear G7a, and the first drive shaft 4 are disconnected.

The second meshing mechanism SM2 is configured to be switchable to either a second-speed-side connection mode, in which the second-speed drive gear G2a and the second drive shaft 5 are connected, or a neutral mode, in which the second-speed drive gear G2a and the second drive shaft 5 are disconnected. The fourth meshing mechanism SM4 is configured to be switchable among a fourth-speed-side connection mode, in which the fourth-speed drive gear G4a and the second drive shaft 5 are connected, a sixth-speed-side connection mode, in which the sixth-speed drive gear G6a and the second drive shaft 5 are connected, and a neutral mode, in which the fourth-speed drive gear G4a and the sixth-speed drive gear G6a, and the second drive shaft 5 are disconnected.

The reverse shaft 6 is provided with a fifth meshing mechanism SM5, which is comprised of a synchronous meshing mechanism and which is switchable between a connection mode, in which the reverse drive gear GRa and the reverse shaft 6 are connected, and the neutral mode, in which the connection is removed.

Further, the power control unit ECU controls the actuator (not illustrated) of the clutch control circuit 10 to adjust the hydraulic pressure, thereby switching between the engaged mode and the disengaged mode of both the clutches, C1 and C2.

A parking gear Gp is splined in the axial direction to the second-speed drive gear G2a in an integrally rotatable manner. Further, the power transmission apparatus TM according to the present embodiment is provided with an engagement section LKa composed of a parking pole, which can be engaged with the parking gear Gp. The parking gear Gp and the engagement section LKa constitute a parking mechanism LK of the present embodiment. The parking mechanism LK is actuated in response to an instruction from the power control unit ECU.

A description will now be given of the operation of the power transmission apparatus TM configured as described above. In the power transmission apparatus TM according to the present embodiment, the internal combustion engine ENG can be started using the driving force of the electric motor MG by engaging the first clutch C1.

First, in order to establish the first-speed stage by using the driving force of the internal combustion engine ENG the lock mechanism B1 (the brake) is set to a locked mode, the ring gear Ra of the planetary gear mechanism PG is fixed to the transmission case 7, and the first clutch C1 is engaged to set the engaged mode.

The driving force of the internal combustion engine ENG is input to the sun gear Sa of the planetary gear mechanism PG through the input shaft 2, the first clutch C1 and the first drive shaft 4, the number of revolutions of the internal combustion engine ENG input to the input shaft 2 is reduced to 1/(g+1), and the reduced number of revolutions is transmitted to the fifth-speed drive gear G5a through the carrier Ca.

The driving force transmitted to the fifth-speed drive gear G5a is changed to 1/i(g+1), the gear ratio of the fifth-speed gear train G5, which is composed of the fifth-speed drive gear G5a and the second driven gear Go2 (the number of teeth of the fifth-speed drive gear G5a/the number of teeth of the second driven gear Go2) being denoted by i, and the 1/i(g+1) is output from the output gear 3 through the second driven gear Go2 and the output shaft 3a, thus establishing the first-speed stage.

As described above, according to the power transmission apparatus TM of the present embodiment, the first-speed stage can be established by the planetary gear mechanism PG and the fifth-speed gear train G5, thus eliminating the need for a meshing mechanism exclusively used for the first-speed stage. In addition, the planetary gear mechanism PG is disposed in the hollow electric motor MG so that the axial length of the power transmission apparatus TM can be further reduced.

At the first-speed stage, if the vehicle is decelerating and the charging rate SOC (State of Charge) of the secondary battery BAIT is below a predetermined value, then the power control unit ECU carries out a deceleration regeneration operation to generate power by applying a brake by the electric motor MG. Further, if the charging rate SOC of the secondary battery BAIT is the predetermined value or more, then a HEV (Hybrid Electric Vehicle) drive mode, in which the electric motor MG is driven to supplement the driving force of the internal combustion engine ENG or an EV (Electric Vehicle) drive mode, in which the vehicle travels solely on the driving force of the electric motor MG can be implemented.

Further, during the EV drive mode, if the deceleration of the vehicle is allowed and the vehicle speed is a predetermined speed or higher, then the internal combustion engine ENG can be started using the kinetic energy of the vehicle without using the driving force of the electric motor MG by slowly engaging the first clutch C1.

Further, if the power control unit ECU predicts, on the basis of vehicle information, including the vehicle speed, the opening degree of an accelerator pedal and the like, that an upshift to the second-speed stage will take place while traveling at the first-speed stage, then the second meshing mechanism SM2 is set to the second-speed side connection mode, in which the second-speed drive gear G2a and the second drive shaft 5 are connected, or to a pre-shift mode for setting the second meshing mechanism SM2 close to the second-speed side connection mode.

Establishing the second-speed stage by using the driving force of the internal combustion engine ENG is accomplished by setting the second meshing mechanism SM2 to the second-speed side connection mode, in which the second-speed drive gear G2a and the second drive shaft 5 are connected, setting the first clutch C1 to the disengaged mode, and engaging the second clutch C2 to set the engaged mode. Thus, the driving force of the internal combustion engine ENG is output from the output gear 3 through the second clutch C2, the idle gear train Gi, the second drive shaft 5, the second-speed gear train G2, and the output shaft 3a.

At the second-speed stage, if the power control unit ECU predicts that an upshift will take place, then the first meshing mechanism SM1 is set to the third-speed side connection mode, in which the third-speed drive gear G3a and the first drive shaft 4 are connected, or to the pre-shift mode for setting the first meshing mechanism SM1 close to the third-speed side connection mode.

Conversely, if the power control unit ECU predicts that a downshift will take place, then the first meshing mechanism SM1 is set to the neutral mode, in which the third-speed drive gear G3a and the first drive shaft 4 are disconnected, and the third meshing mechanism SM3 is set to the neutral mode, in which the fifth-speed drive gear G5a and the first drive shaft 4 are disconnected.

Thus, the upshift or the downshift can be accomplished simply by setting the first clutch C1 to the engaged mode and the second clutch C2 to the disengaged mode. This permits smooth shifting among transmission stages without interrupting a driving force.

Further, also in the second-speed stage, if the vehicle is decelerating and the charging rate SOC of the secondary battery BAIT is below the predetermined value, then the power control unit ECU carries out the deceleration regeneration operation. The deceleration regeneration operation at the second-speed stage differs, depending on whether the first meshing mechanism SM1 is in the third-speed side connection mode or the neutral mode.

If the first meshing mechanism SM1 is in the third-speed side connection mode, then the third-speed drive gear G3a, which is rotated by the first driven gear Go1 rotated by the second-speed drive gear G2a, causes the rotor MGb of the electric motor MG to rotate through the first drive shaft 4, so that the rotation of the rotor MGb is restrained to apply a brake so as to generate power, thus performing the regenerative operation.

If the first meshing mechanism SM1 is in the neutral mode, then the lock mechanism B1 is set to the locked mode so as to set the number of revolutions of the ring gear Ra to zero, and applying a brake to the revolution of the carrier Ca by generating power by the electric motor MG connected to the sun gear Sa, thus performing the regenerative operation.

Further, the HEV drive at the second-speed stage can be accomplished by, for example, setting the first meshing mechanism SM1 to the third-speed side connection mode, in which the third-speed drive gear G3a and the first drive shaft 4 are connected, so as to transmit the driving force of the electric motor MG to the output gear 3 through the third-speed gear train G3.

Alternatively, the HEV drive at the second-speed stage can be accomplished by setting the third meshing mechanism SM3 to the fifth-speed side connection mode, in which the fifth-speed drive gear G5a and the first drive shaft 4 are connected, so as to set the planetary gear mechanism PG in the locked mode, which disables the relative rotation of the elements thereof, and by transmitting the driving force of the electric motor MG to the output gear 3 through the fifth-speed gear train G5.

Further alternatively, the HEV drive at the second-speed stage can be accomplished by setting the first meshing mechanism SM1 in the neutral mode, and setting the lock mechanism B1 (the brake) to a reverse rotation prevention mode, setting the number of revolutions of the ring gear Ra to zero, and transmitting the driving force of the electric motor MG to the first driven gear Go1 through the path of the first-speed stage.

Establishing the third-speed stage by using the driving force of the internal combustion engine ENG is accomplished by setting the first meshing mechanism SM1 to the third-speed side connection mode, in which the third-speed drive gear G3a and the first drive shaft 4 are connected, disengaging the second clutch C2, and engaging the first clutch C1 to set the engaged mode. This causes the driving force of the internal combustion engine ENG to be transmitted to the output gear 3 through the input shaft 2, the first clutch C1, the first drive shaft 4, the first meshing mechanism SM1, and the third-speed gear train G3, and output at the number of revolutions of 1/i.

At the third-speed stage, if the power control unit ECU predicts from vehicle information that a downshift will take place, including the vehicle speed, the opening degree of an accelerator pedal and the like, then the second meshing mechanism SM2 is set to the second-speed side connection mode, in which the second-speed drive gear G2a and the second drive shaft 5 are connected, or to the pre-shift mode for setting the second meshing mechanism SM2 close to the second-speed side connection mode. If an upshift is predicted, then the fourth meshing mechanism SM4 is set to the fourth-speed side connection mode, in which the fourth-speed drive gear G4a and the second drive shaft 5 are connected, or to the pre-shift mode for setting the fourth meshing mechanism SM4 close to the fourth-speed side connection mode.

Thus, the transmission stage can be switched simply by engaging the second clutch C2 to set the engaged mode while releasing the first clutch C1 to set the disengaged mode. This permits smooth speed change without interrupting the driving force.

Establishing the fourth-speed stage by using the driving force of the internal combustion engine ENG can be accomplished by setting the fourth meshing mechanism SM4 to the fourth-speed side connection mode, in which the fourth-speed drive gear G4a and the second drive shaft 5 are connected, setting the first clutch C1 to the disengaged mode, and engaging the second clutch C2 to set the engaged mode.

While traveling at the fourth-speed stage, if the power control unit ECU predicts from vehicle information that a downshift will take place, then the first meshing mechanism SM1 is set to the third-speed side connection mode, in which the third-speed drive gear G3a and the first drive shaft 4 are connected, or to the pre-shift mode for setting the first meshing mechanism SM1 close to the third-speed side connection mode.

Conversely, if the power control unit ECU predicts from vehicle information that an upshift will take place, then the third meshing mechanism SM3 is set to the fifth-speed side connection mode, in which the fifth-speed drive gear G5a and the first drive shaft 4 are connected, or to the pre-shift mode for setting the third meshing mechanism SM3 close to the fifth-speed side connection mode. Thus, the downshift or the upshift can be accomplished simply by engaging the first clutch C1 to set the engaged mode while releasing the second clutch C2 to set the disengaged mode. This permits smooth speed change without interrupting the driving force.

To perform the deceleration regeneration or the HEV drive while traveling at the fourth-speed stage, if the power control unit ECU predicts that a downshift will take place, then setting the first meshing mechanism SM1 to the third-speed side connection mode, in which the third-speed drive gear G3a and the first drive shaft 4 are connected, and applying a brake by the electric motor MG enable the deceleration regeneration to be performed, or transmitting the driving force from the electric motor MG enables the HEV drive to be performed.

If the power control unit ECU predicts that an upshift will take place, then setting the third meshing mechanism SM3 to the fifth-speed side connection mode, in which the fifth-speed drive gear G5a and the first drive shaft 4 are connected, and applying a brake by the electric motor MG enable the deceleration regeneration to be performed, or transmitting the driving force from the electric motor MG enables the HEV drive to be performed.

Establishing the fifth-speed stage by using the driving force of the internal combustion engine ENG can be accomplished by setting the third meshing mechanism SM3 to the fifth-speed side connection mode, in which the fifth-speed drive gear G5a and the first drive shaft 4 are connected, setting the second clutch C2 to the disengaged mode, and engaging the first clutch C1 to set the engaged mode. At the fifth-speed stage, the first clutch C1 is set in the engaged mode, so that the internal combustion engine ENG and the electric motor MG are directly connected. Thus, if the driving force is output from the electric motor MG, then the HEV drive can be performed, or if a brake is applied by the electric motor MG to generate power, then the deceleration regeneration can be performed.

When performing the EV drive at the fifth-speed stage, the first clutch C1 in addition to the second clutch C2 may be set to the disengaged mode. Further, during the EV drive at the fifth-speed stage, the internal combustion engine ENG can be started by slowly engaging the first clutch C1.

Further, at the fifth-speed stage, the third meshing mechanism SM3 is in the fifth-speed side connection mode, in which the fifth-speed drive gear G5a and the first drive shaft 4 are connected, so that the sun gear Sa and the carrier Ca of the planetary gear mechanism PG rotate the same way.

Hence, the planetary gear mechanism PG is placed in the locked mode, which disables the relative rotations of the elements thereof, and applying a brake to the sun gear Sa by the electric motor MG enables the deceleration regeneration to be performed, or transmitting the driving force from the electric motor MG to the sun gear Sa enables the HEV drive to be performed. In addition, the EV drive in which the vehicle travels solely on the driving force of the electric motor MG, with the first clutch C1 disengaged, can be performed.

While traveling at the fifth-speed stage, if the power control unit ECU predicts from vehicle information that a downshift to the fourth-speed stage will take place, then the fourth meshing mechanism SM4 is set to the fourth-speed side connection mode, in which the fourth-speed drive gear G4a and the second drive shaft 5 are connected, or to the pre-shift mode for setting the fourth meshing mechanism SM4 close to the fourth-speed side connection mode. This permits a smooth downshift to the fourth-speed stage without interrupting the driving force.

Further, at the fifth-speed stage, if the power control unit ECU predicts that an upshift will take place, then the fourth meshing mechanism SM4 is set to the sixth-speed side connection mode, in which the sixth-speed drive gear G6a and the second drive shaft 5 are connected, or to the pre-shift mode for setting the fourth meshing mechanism SM4 close to the sixth-speed side connection mode. Thus, the transmission stage can be switched simply by engaging the second clutch C2 to set the engaged mode while releasing the first clutch C1 to set the disengaged mode. This permits smooth speed change without interrupting the driving force.

Establishing the sixth-speed stage by using the driving force of the internal combustion engine ENG can be accomplished by setting the fourth meshing mechanism SM4 to the sixth-speed side connection mode, in which the sixth-speed drive gear G6a and the second drive shaft 5 are connected, setting the first clutch C1 to the disengaged mode, and engaging the second clutch C2 to set the engaged mode.

While traveling at the sixth-speed stage, if the power control unit ECU predicts from vehicle information that a downshift will take place, then the third meshing mechanism SM3 is set to the fifth-speed side connection mode, in which the fifth-speed drive gear G5a and the first drive shaft 4 are connected, or to the pre-shift mode for setting the third meshing mechanism SM3 close to the fifth-speed side connection mode.

Conversely, if the power control unit ECU predicts from vehicle information that an upshift will take place, then the third meshing mechanism SM3 is set to the seventh-speed side connection mode, in which the seventh-speed drive gear G7a and the first drive shaft 4 are connected, or to the pre-shift mode for setting the third meshing mechanism SM3 close to the seventh-speed side connection mode. Thus, the downshift or the upshift can be accomplished simply by engaging the first clutch C1 to set the engaged mode while releasing the second clutch C2 to set the disengaged mode. This permits smooth speed change without interrupting the driving force.

To perform the deceleration regeneration or the HEV drive while traveling at the sixth-speed stage, if the power control unit ECU predicts that a downshift will take place, then setting the third meshing mechanism SM3 to the fifth-speed side connection mode, in which the fifth-speed drive gear G5a and the first drive shaft 4 are connected, and applying a brake by the electric motor MG enable the deceleration regeneration to be performed, or transmitting the driving force enables the HEV drive to be performed.

If the power control unit ECU predicts that an upshift will take place, then setting the third meshing mechanism SM3 to the seventh-speed side connection mode, in which the seventh-speed drive gear G7a and the first drive shaft 4 are connected, and applying a brake by the electric motor MG enable the deceleration regeneration to be performed, or transmitting the driving force from the electric motor MG enables the HEV drive to be performed.

Establishing the seventh-speed stage by using the driving force of the internal combustion engine ENG can be accomplished by setting the third meshing mechanism SM3 to the seventh-speed side connection mode, in which the seventh-speed drive gear G7a and the first drive shaft 4 are connected, setting the second clutch C2 to the disengaged mode, and engaging the first clutch C1 to set the engaged mode. At the seventh-speed stage, the first clutch C1 is set in the engaged mode, so that the internal combustion engine ENG and the electric motor MG are directly connected. Thus, if the driving force is output from the electric motor MG then the HEV drive can be performed, or if a brake is applied by the electric motor MG to generate power, then the deceleration regeneration can be performed.

When performing the EV drive at the seventh-speed stage, the first clutch C1 in addition to the second clutch C2 may be set to the disengaged mode. Further, during the EV drive at the seventh-speed stage, the internal combustion engine ENG can be started by slowly engaging the first clutch C1.

While traveling at the seventh-speed stage, if the power control unit ECU predicts from vehicle information that a downshift to the sixth-speed stage will take place, then the fourth meshing mechanism SM4 is set to the sixth-speed side connection mode, in which the sixth-speed drive gear G6a and the second drive shaft 5 are connected, or to the pre-shift mode for setting the fourth meshing mechanism SM4 close to the sixth-speed side connection mode. This permits a smooth downshift to the sixth-speed stage without interrupting the driving force.

Establishing the reverse stage by using the driving force of the internal combustion engine ENG is accomplished by setting the lock mechanism B1 in the locked mode, setting the fifth meshing mechanism SM5 to the connection mode, in which the reverse drive gear GRa and the reverse shaft 6 are connected, and engaging the second clutch C2 to set the engaged mode. This changes the revolution speed of the input shaft 2 to the negative rotation (the rotation in the reverse direction) of the revolution speed of [the number of teeth of the idle drive gear Gia/the number of teeth of the third idle driven gear Gid]×[the number of teeth of the reverse drive gear GRa/the number of teeth of the reverse driven gear GRb]×[1/i(g+1)], and the negative rotation is output from the output gear 3, thus establishing the reverse stage.

Further, at the reverse stage, generating a driving force on the normal rotation side and applying a brake to the rotor MGb rotating in the reverse direction cause the deceleration regeneration to be performed, or generating a driving force on the reverse rotation side enables the HEV drive to be performed. Further, with both the clutches C1 and C2 set to the disengaged mode and the lock mechanism B1 (the brake) set to the locked mode, the reverse stage can be established in the EV drive by rotating the electric motor MG in the reverse direction.

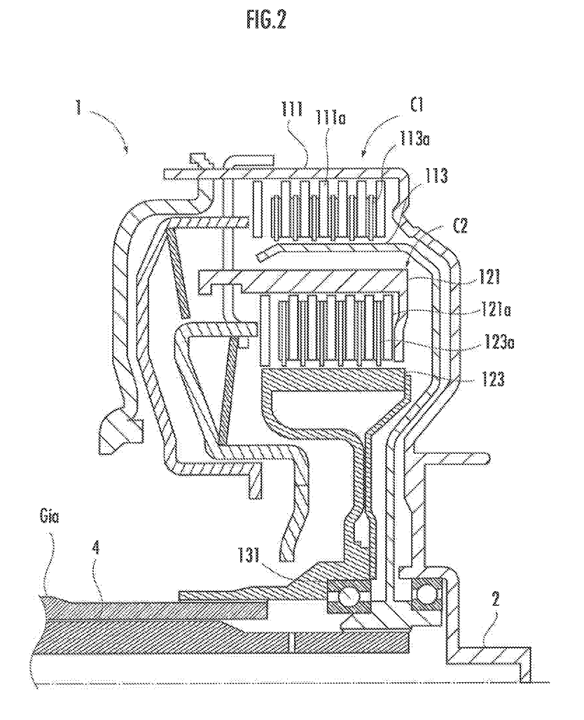

Referring now to FIG. 2, the clutch device 1 according to the present embodiment will be described. The clutch device 1 according to the present embodiment is comprised of the first clutch C1 and the second clutch C2. The first clutch C1 is a multi-disc friction clutch and composed of a cylindrical first outer drum 111 connected to the input shaft 2, a first inner hub 113 disposed with an interval provided on the inner side in the radial direction of the first outer drum 111, a plurality of first outer plates 111a disposed between the first outer drum 111 and the first inner hub 113, and a plurality of first inner discs 113a disposed among the first outer plates 111a. The first outer plates 111a can be frictionally engaged with the first inner discs 113a by being pressed by a piston.

The first outer plates 111a are annular and have a plurality of hooks, which protrude outward, on the outer rims of the first outer plates 111a in the circumferential direction with intervals provided thereamong. The hooks of the first outer plates 111a are individually engaged with a plurality of engagement grooves, which are provided in the inner peripheral surface of the first outer drum 111 and which extend in the direction of the rotation axis. Thus, the first outer plates 111a are engaged to be movable in the direction of the rotation axis relative to the first outer drum 111 and to rotate integrally therewith.

The first inner discs 113a are annular and have a plurality of hooks, which protrude inward, on the inner rims of the first inner discs 113a in the circumferential direction with intervals provided thereamong. The hooks of the first inner discs 113a are individually engaged with a plurality of engagement grooves, which are provided in the outer peripheral surface of the first inner hub 113 and which extend in the direction of the rotation axis. Thus, the first inner discs 113a are engaged to be movable in the direction of the rotation axis relative to the first inner hub 113 and to rotate integrally therewith. The first inner hub 113 is splined to the first drive shaft 4.

The second clutch C2 is a multi-disc friction clutch and comprised of a cylindrical second outer drum 121 connected to the first outer drum 111 of the first clutch C1, a second inner hub 123 disposed with an interval provided on the inner side in the radial direction of the second outer drum 121, a plurality of second outer plates 121a disposed between the second outer drum 121 and the second inner hub 123, and a plurality of second inner discs 123a disposed among the second outer plates 121a. The second outer plates 121a can be frictionally engaged with the second inner discs 123a by being pressed by a piston.

The second outer plates 121a are annular and have a plurality of hooks, which protrude outward, on the outer rims of the second outer plates 121a in the circumferential direction with intervals provided thereamong. The hooks of the second outer plates 121a are individually engaged with a plurality of engagement grooves, which are provided in the inner peripheral surface of the second outer drum 121 and which extend in the direction of the rotation axis. Thus, the second outer plates 121a are connected to be movable in the direction of the rotation axis relative to the second outer drum 121 and to rotate integrally therewith.

The second inner discs 123a are annular and have a plurality of hooks, which protrude inward, on the inner rims of the second inner discs 123a in the circumferential direction with intervals provided thereamong. The hooks of the second inner discs 123a are individually engaged with a plurality of engagement grooves, which are provided in the outer peripheral surface of the second inner hub 123 and which extend in the direction of the rotation axis. Thus, the second inner discs 123a are connected to be movable in the direction of the rotation axis relative to the second inner hub 123 and to rotate integrally therewith. The second inner hub 123 is splined to the rotating shaft of the idle drive gear Gia. A ball bearing 131 is provided between the second inner hub 123 and the first inner hub 113.

According to the present embodiment, the ball bearing 131 is provided between the second inner hub 123 and the first inner hub 113, so that the second inner hub 123 is securely held by the first inner hub 113 through the intermediary of the ball bearing 131. This makes it possible to prevent the second inner hub 123 from inclining.

In the present embodiment, the first outer drum 111 corresponds to the first input member of the present invention, the first inner hub 113 corresponds to the first output member of the present invention, the second outer drum 121 corresponds to the second input member of the present invention, and the second inner hub 123 corresponds to the second output member of the present invention.

In the present embodiment, the description has been given of the case where the outer drums 111 and 121 of both the clutches C1 and C2 are connected and integrally rotated; however, the clutch device according to the present invention is not limited thereto. For example, the inner hubs of both the clutches C1 and C2 may be connected to provide the first and the second input members that integrally rotate, and the outer drums may be handled as different drums, namely, the first and the second output members. In this case, one of the outer drums may be journaled by the other outer drum through a taper bearing thereby to prevent the second outer drum functioning as the second output member from inclining.

### Comparative Example

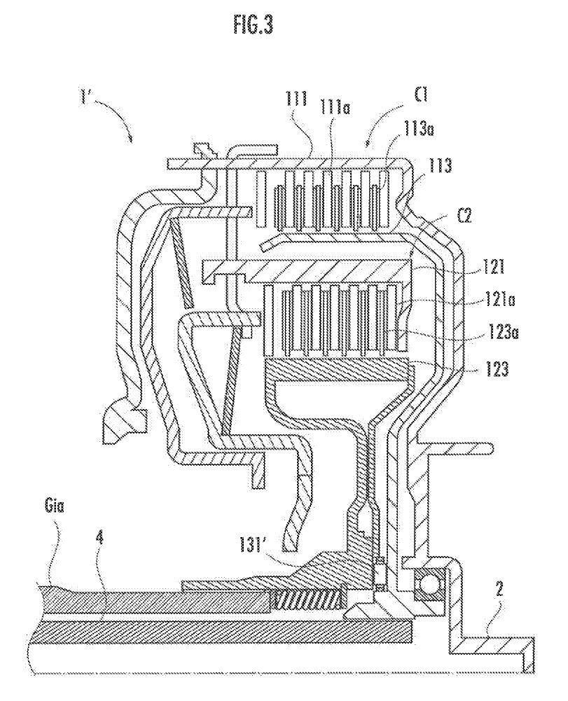

FIG. 3 illustrates a clutch device 1′ as a comparative example. The clutch device 1′ is provided with a thrust bearing 131′ rather than the ball bearing 131. According to the clutch device 1′ of the comparative example, a second inner hub 123 easily inclines.

What is claimed is:

1. A clutch device comprising: a first clutch and a second clutch that disengageably transmit a rotational motion, wherein
the first clutch includes:
a first outer drum;
a first outer plate which is slidable in an axial direction with respect to the first outer drum and which is connected to an inner wall so as to rotate integrally with the first outer drum;
a first inner hub concentrically disposed on an inner side in a radial direction of the first outer drum; and
a first inner disc which is slidable in the axial direction with respect to the first inner hub, which is connected to an outer wall so as to rotate integrally with the first inner hub, and which is frictionally engageable with the first outer plate,
the second clutch includes:
a second outer drum;
a second outer plate which is slidable in the axial direction with respect to the second outer drum and which is connected to an inner wall so as to rotate integrally with the second outer drum;
a second inner hub concentrically disposed on an inner side in a radial direction of the second outer drum; and
a second inner disc which is slidable in the axial direction with respect to the second inner hub, which is connected to an outer wall so as to rotate integrally with the second inner hub, and which is frictionally engageable with the second outer plate,
one of the first outer plate and the first inner hub is defined as a first input member and the other is defined as a first output member,
one of the second outer plate and the second inner hub is defined as a second input member and the other is defined as a second output member,
the first input member and the second input member are connected, and
the second output member is journaled by the first output member through the intermediary of a ball bearing.
